(19) United States
(12) Patent Application Publication
(10) Pub. No.: US 2018/0234977 A1
(43) Pub. Date: Aug. 16, 2018

(54) CONTROL APPARATUS, USER APPARATUS, RADIO RESOURCE ALLOCATION METHOD AND COMMUNICATION METHOD

(71) Applicant: NTT DOCOMO, INC., Tokyo (JP)

(72) Inventors: Shimpei Yasukawa, Tokyo (JP); Satoshi Nagata, Tokyo (JP); Qun Zhao, Beijing (CN)

(73) Assignee: NTT DOCOMO, INC., Tokyo (JP)

(21) Appl. No.: 15/751,106

(22) PCT Filed: Aug. 9, 2016
(86) PCT No.: PCT/JP2016/073489

§ 371 Date: Feb. 7, 2018

(30) Foreign Application Priority Data
Aug. 13, 2015 (JP) 2015-159993

(51) Int. Cl. H04W 72/08; H04W 72/04; H04W 76/14; H04W 74/08; H04W 8/00; H04W 48/16

(52) U.S. Cl. CPC H04W 72/08; H04W 72/048; H04W 76/14; H04W 92/18; H04W 8/005; H04W 48/16; H04W 74/0808

(57) ABSTRACT

A control apparatus according to an embodiment is provided. The control apparatus is included in a wireless communication system that includes the control apparatus, which performs radio resource allocation for D2D communications, and a user apparatus. The control apparatus includes a detection unit configured to detect the user apparatus by receiving a D2D signal transmitted from the user apparatus; an allocation unit configured to allocate a specific radio resource to be used by the user apparatus for transmitting a D2D signal in the case where the user apparatus is detected; and a transmission unit configured to transmit a signal indicating the allocated specific radio resource to the user apparatus.

### BACKGROUND OF THE INVENTION

### 1. Field of the Invention

The present invention relates to a control apparatus, a user apparatus, a radio resource allocation method, and a communication method.

### 2. Description of the Related Art

In an LTE (Long Term Evolution) system and an LTE successor system (also referred to as LTE-A [LTE advanced], FRA [Future Radio Access], 4G, etc.), D2D (Device to Device) technologies in which user terminals directly communicate with each other without via a radio base station have been discussed (e.g., NPL 1).

According to D2D, it is possible to reduce traffic between a user apparatus and a base station, and it is possible for user apparatuses to communicate with each other even in the case where a base station is not available for communications at the time of disasters.

D2D is roughly categorized into “D2D discovery”, a term used for discovering another communication-available user terminal, and “D2D communications” (also referred to as D2D direct communications, inter-terminal direct communications, etc.), a term used for direct communications between user terminals. In the following, when “D2D communications” and “D2D discovery” are not particularly distinguished, they are simply referred to as D2D. Further, a signal transmitted and received in D2D is referred to as a D2D signal.

Further, in 3GPP (3rd Generation Partnership Project), enhancing D2D functions has been discussed in order to realize V2X. Here, V2X is a part of ITS (Intelligent Transport Systems). V2X is a generic name for V2V (Vehicle to Vehicle), V2I (Vehicle to Infrastructure), V2N (Vehicle to Nomadic device), and V2P (Vehicle to Pedestrian). V2V means communications between vehicles, V2I means communications between a vehicle and a road-side unit installed on the roadside, V2N means communications between a vehicle and a driver's mobile terminal, and V2P means communications between a vehicle and a pedestrian's mobile terminal.

### CITATION LIST

### Non-Patent Literature

[NPL 1] “Key drivers for LTE success: Services Evolution”, September 2011, 3GPP, the Internet URL: //www.3gpp.org/ftp/Information/presentations/presentations_2011/2011_09_LTE_Asia/2011_LTE-Asia_3GPP_Service_evolution.pdf

### SUMMARY OF THE INVENTION

### Technical Problem

In V2X, it is necessary to realize communications under an environment in which a lot of user apparatuses (vehicles, etc.) exist; it is necessary to take into account the constraints of half duplex communications (Half Duplex) that are characteristics of D2D communications; and it is necessary to reduce interference and to efficiently allocate radio resources.

In D2D, a method is specified in which a base station eNB performs radio resource allocation for D2D communications within the coverage. By using this method, it is possible to realize radio resource allocation without generating interference between user apparatuses even in an environment in which many user apparatuses exist. However, this method requires RRC connections to be established in advance between the user apparatuses and the base station eNB within the coverage, and thus, an amount of transmitted and received control signals is large and overhead is high before radio resources can be allocated. Further, in D2D, a method is also specified in which a user apparatus randomly selects a radio resource from the radio resources reserved in advance for D2D communications, mainly outside the coverage. However, in this method, because user apparatuses randomly select radio resources, considerable interference is generated under an environment in which many user apparatuses exist, which is not suitable.

Here, with the assumption that an RSU is installed at locations including a city center or an intersection where user apparatuses (vehicles) tend to concentrated, functions have been dismissed including a signal relay function in which emergency information generated by a user apparatus (vehicle) is transmitted to surrounding user apparatuses (vehicles), and an information delivery function in which information from a camera installed at the intersection is transmitted to user apparatuses (vehicles) around the intersection. Therefore, if it is possible for the RSU to allocate radio resources for D2D communications, then the interference reduction and the efficient radio resource allocation can be realized without establishing RRC connections between user apparatuses and a base station eNB as in the conventional way.

The present invention has been made in view of the above. It is an object of the present invention to provide a technology in which it is possible to efficiently allocate radio resources used for D2D communications.

### Solution to Problem

A control apparatus according to an embodiment is provided. The control apparatus is provided for a wireless communication system including the control apparatus, which allocates radio resources for D2D communications, and a user apparatus. The control apparatus includes a detection unit configured to detect the user apparatus, by receiving a D2D signal transmitted from the user apparatus; an allocation unit configured to allocate a specific radio resource to be used by the user apparatus for transmitting a D2D signal, in the case where the user apparatus is detected; and a transmission unit configured to transmit a signal indicating the allocated specific radio resource to the user apparatus.

Further, a user apparatus according to an embodiment is provided. The user apparatus is provided for a wireless communication system including a control apparatus, which allocates radio resources for D2D communications, and the user apparatus. The user apparatus includes a detection unit configured to detect the control apparatus, by receiving an identification signal transmitted from the control apparatus; a request unit configured to transmit to the detected control apparatus a signal requesting the detected control apparatus to allocate a radio resource for D2D communications; and a transmission unit configured to transmit a D2D signal by using the specific radio resource for D2D communications allocated by the control apparatus.

### Advantageous Effects of Invention

According to an embodiment, a technology is provided in which it is possible to efficiently allocate radio resources used for D2D communications.

### BRIEF DESCRIPTION OF THE DRAWINGS

FIG. 1 is a drawing illustrating V2X.

FIG. 2 is a drawing illustrating an example of a structure of a wireless communication system according to an embodiment.

FIG. 3 is a drawing illustrating D2D communications.

FIG. 4 is a drawing illustrating MAC PDU used for D2D communications.

FIG. 5 is a drawing illustrating a format for a SL-SCH sub-header.

FIG. 6 is a sequence diagram illustrating radio resource allocation processing (No. 1).

FIG. 7 is a sequence diagram illustrating radio resource allocation processing (No. 2).

FIG. 8 is a sequence diagram illustrating radio resource release processing (No. 1).

FIG. 9 is a sequence diagram illustrating radio resource release processing (No. 2).

FIG. 10 is a sequence diagram illustrating radio resource release processing (No. 3).

FIG. 11 is a drawing illustrating an example of a functional structure of a user apparatus according to an embodiment.

FIG. 12 is a drawing illustrating an example of a functional structure of an RSU according to an embodiment.

FIG. 13 is a drawing illustrating an example of a hardware configuration of a user apparatus and an RSU according to an embodiment.

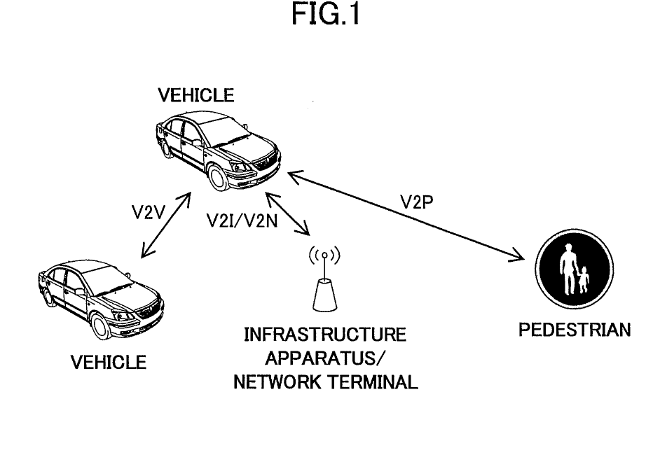

### DETAILED DESCRIPTION OF THE PREFERRED EMBODIMENTS

In the following, referring to the drawings, embodiments of the present invention will be described. It should be noted that the embodiments described below are merely examples and the embodiments to which the present invention is applied are not limited to the following embodiments. For example, it is assumed that a wireless communication system according to an embodiment complies with LTE standards. However, the present invention can be applied not only to LTE, but also to other schemes. It should be noted that, in the application specification and claims, the term “LTE” is used, not only for meaning a communication method corresponding to 3GPP release 8 or 9, but also for meaning a communication method corresponding to 3GPP release 10, 11, 12, 13, or a fifth generation communication method corresponding to release 14, or later.

### Overview

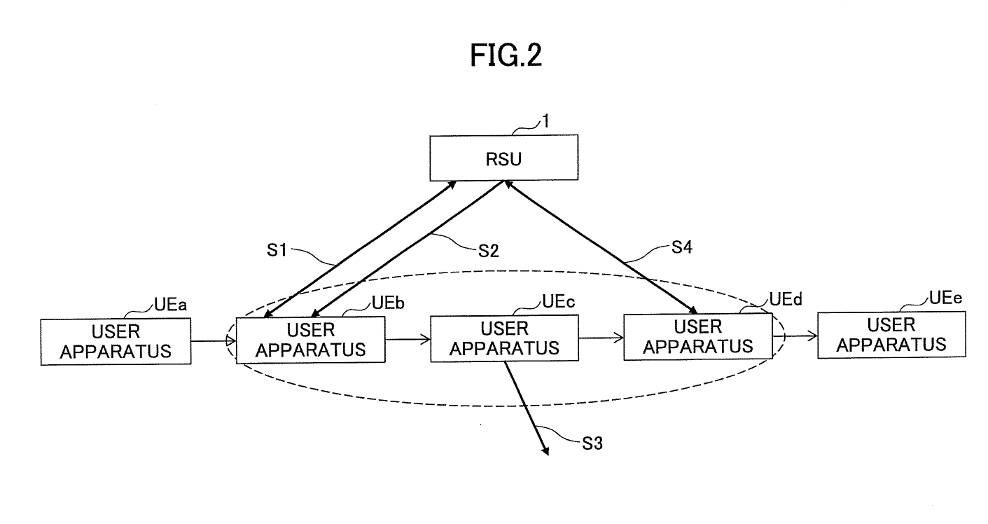

As illustrated in FIG. 2, a wireless communication system according to an embodiment supports D2D communications and includes an RSU 1 and user apparatuses UE that transmit a D2D signal. It should be noted that, although user apparatuses UEa to UEe are illustrated in FIG. 2, the user apparatuses UEa to UEe are the same user apparatus UE. FIG. 2 illustrates that movement is from a position of the user apparatus UEa to UEb, UEc, UEd, and UEe in this order.

In D2D communications, some of the uplink resources predefined as resources for uplink signal transmission from a user apparatus UE to a base station eNB are used. Here, an overview of D2D signal transmission in LTE will be described.

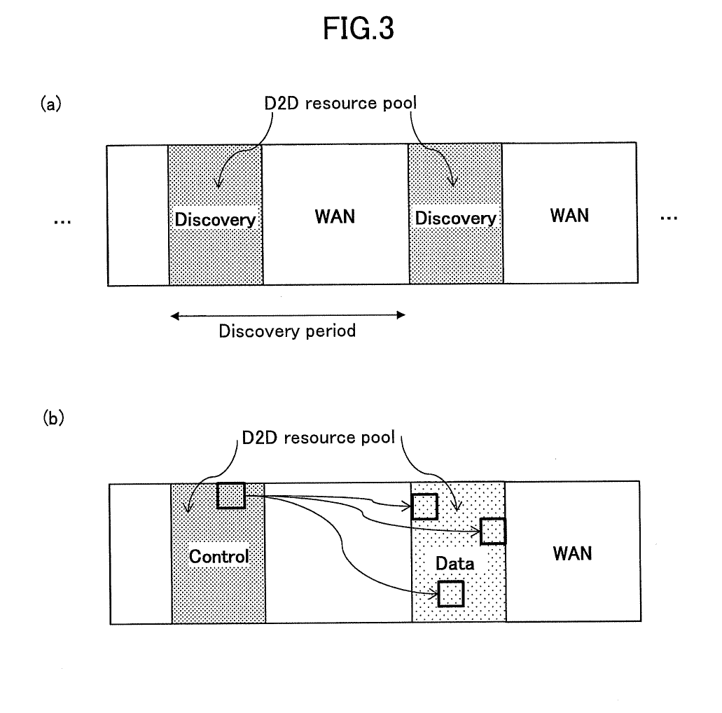

Regarding the “Discovery”, as illustrated in FIG. 3 (a), a resource pool for a Discovery message is reserved in each Discovery period, and the user apparatus UEa transmits a Discovery signal in the resource pool. More specifically, within “Discovery”, there is a Type 1 and a Type 2b as follows: In Type 1, the user apparatus UEa autonomously selects a transmission resource from the resource pool. In Type 2b, a more semi-static transmission resource is allocated by upper layer signaling (e.g., an RRC signal).

Regarding the “Communications”, as illustrated in FIG. 3 (b), resource pools for Control/Data transmissions are periodically reserved. The transmission side user apparatus UEa transmits (indicates/reports) a Data transmission resource to a reception side user apparatus UEb by using SCI (Sidelink Control Information) through a resource selected from the Control resource pool, and transmits Data by using the Data transmission resource. More specifically, within “Communications”, there is a Mode 1 and a Mode 2 as follows: In Mode 1, resources are allocated dynamically by an (E)PDCCH transmitted from a base station eNB to a user apparatus UE. In Mode 2, the user apparatus UEa autonomously selects a transmission resource from the Control/Data transmission resource pools. The resource pools are transmitted (indicated/reported) by SIB or are defined in advance.

In LTE, the channel used for “Discovery” is referred to as a PSDCH (Physical Sidelink Discovery Channel), the channel used for transmission of control information in “Communications” such as an SCI is referred to as a PSCCH (Physical Sidelink Control Channel), and the channel used for data transmission is referred to as a PSSCH (Physical Sidelink Shared Channel).

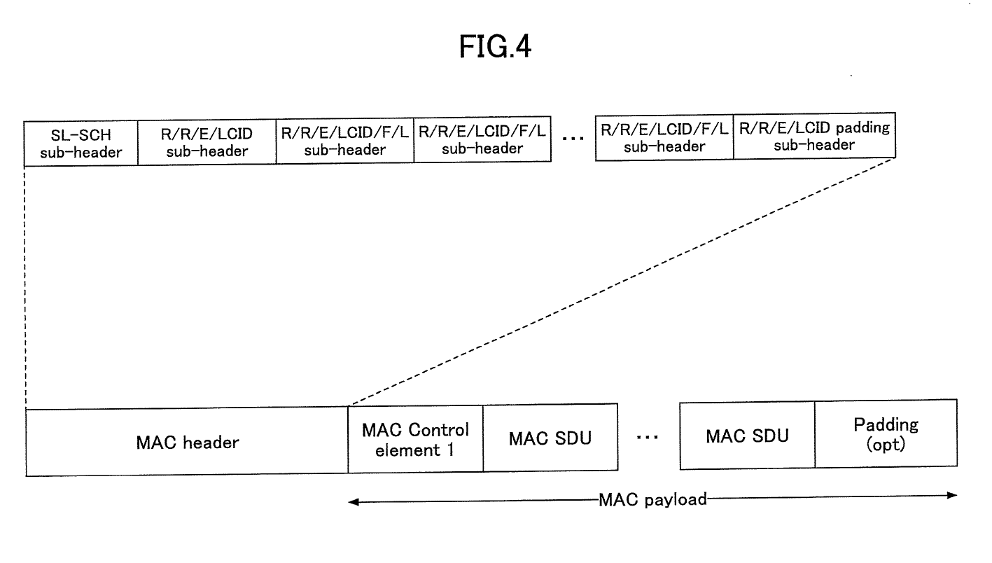

A MAC (Medium Access Control) PDU (Protocol Data Unit) used for D2D communications includes at least a MAC header, a MAC Control element, a MAC SDU (Service Data Unit), and a Padding as illustrated in FIG. 4. The MAC PDU may include other information. The MAC header includes one SL-SCH (Sidelink Shared Channel) sub-header and one or more MAC PDU sub-headers.

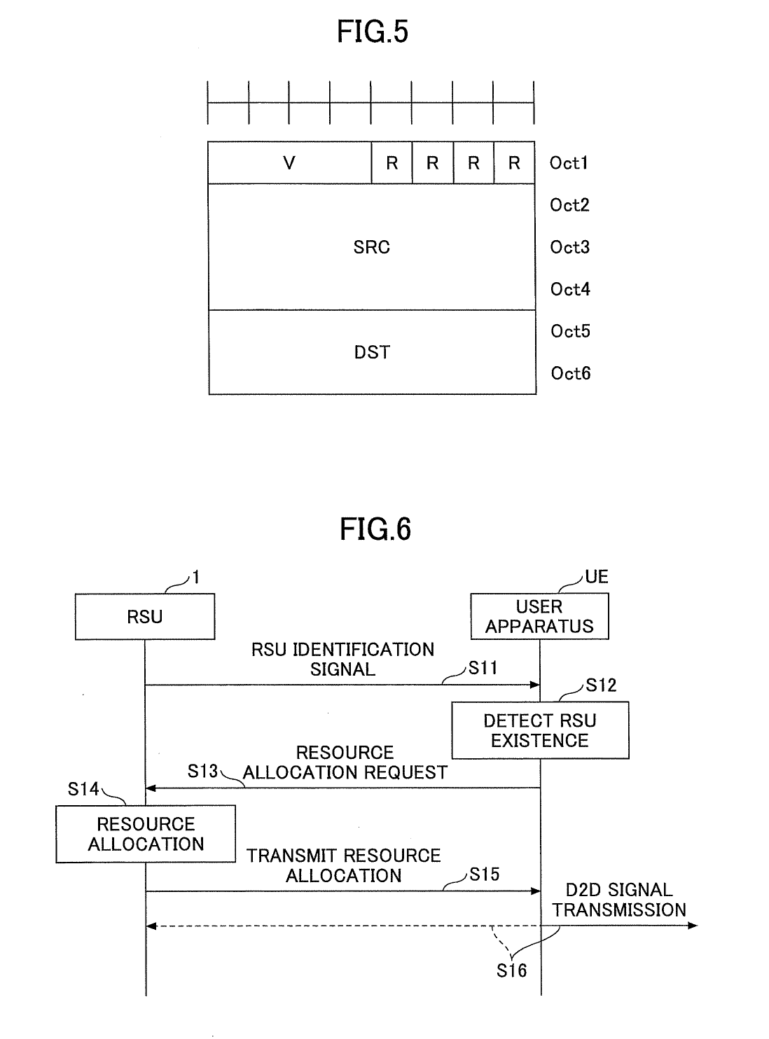

As illustrated in FIG. 5, the SL-SCH sub-header includes a MAC PDU format version (V), transmission source information (SRC), transmission destination information (DST), Reserved bits (R), etc. The “V” is allocated at the beginning of the SL-SCH sub-header, and indicates a MAC PDU format version used by the user apparatus UE. In the transmission source information, information related to a transmission source is set. In the transmission source information, an identifier related to a ProSe UE ID may be set. In the transmission destination information, information related to a transmission destination is set. In the transmission destination information, information related to a ProSe Layer-2 Group ID of the transmission destination may be set.

Referring to FIG. 2, an overview of operations performed by a wireless communication system according to an embodiment will be described. First, the user apparatus UE moves from a position of the user apparatus UEa to a position of the user apparatus UEb. An RSU 1 detects that the user apparatus UE is approaching (coming close to) the location where the RSU 1 is installed (S1), selects a radio resource allocated for the user apparatus UE from the resource pool, and transmits (indicates/reports) the selected radio resource to the user apparatus UE (S2). The user apparatus UE transmits a D2D signal by using the transmitted (indicated/reported) radio resource while moving from a position of the user apparatus UEb to a position of the user apparatus UEc (S3). When the user apparatus UE moves to a position of the user apparatus UEd, the RSU 1 determines that the user apparatus UE has moved away from the location where the RSU 1 is installed (S4), and releases the radio resource that has been allocated for the user apparatus UE. The user apparatus UEd moves to a position where the RSU 1 does not detect the user apparatus UE (a position of the user apparatus UEe). Further, the RSU 1 performs processing steps of S1 to S4 for each user apparatus UE existing around the RSU 1, and allocates radio resources in such a way that the radio resources do not overlap among the user apparatuses UE (in such a way that the radio resources are orthogonal to each other). With the above arrangement, it is possible for the user apparatus UE to perform D2D communications without interfering with other user apparatuses UE in an area where the RSU 1 can detect the user apparatus UE.

A user apparatus UE according to an embodiment includes a vehicle, a driver's mobile terminal, and a pedestrian's mobile terminal, which are terms defined for V2X. Further, with respect to the RSU 1, a “user apparatus type RSU (UE type RSU)”, which is realized as a type of user apparatus UE and includes functions of a user apparatus UE, and a “base station type RSU (eNB type RSU)”, which is realized as a type of base station eNB in D2D and includes functions of a base station eNB, are both defined as the RSU 1. According to an embodiment, the term RSU 1 is used to mean, unless otherwise noted, to include both the user apparatus type RSU and the base station type RSU.

### Processing Steps

In the following, specific processing steps performed by a wireless communication system according to an embodiment will be described. First, processing steps will be described in which an RSU 1 allocates a radio resource for a user apparatus UE that is approaching (coming close to) a position where the RSU 1 is installed. Next, processing steps will be described in which the RSU 1 releases the radio resource allocated for the user apparatus UE that has moved away from the position where the RSU 1 is installed.

(Radio Resource Allocation (No. 1))

FIG. 6 is a sequence diagram illustrating radio resource allocation processing (No. 1). In the processing steps, the user apparatus UE detects a presence of the RSU 1, and requests the RSU 1 to allocate a radio resource.

First, the RSU 1 transmits an RSU identification signal (S11). The RSU identification signal may be any signal as long as it is possible for the user apparatus UE to identify that the signal is transmitted from the RSU 1. Upon receiving the RSU identification signal, the user apparatus UE detects that the RSU 1 is present near the user apparatus UE (S12).

Here, as an example, the RSU 1 may have a special address (e.g., an address L1 exclusive to other UEs, an address L1 in an address range L2, or an address L2), and transmit an RSU identification signal including the address. Upon receiving the RSU identification signal, the user apparatus UE can determine that the RSU identification signal has been transmitted from the RSU 1 based on the address.

It should be noted that the RSU identification signal may be an SCI including the address transmitted by using a PSCCH, may be a MAC PDU including the address in the MAC header or the like transmitted by using a PSSCH, or may be a signal including the address transmitted by using a PSDCH. The user apparatus UE may receive the RSU identification signal by monitoring the entire resource pool allocated for a PSCCH, a PSSCH, or a PSDCH. Further, the RSU identification signal may be transmitted by using a resource pool especially allocated for the RSU identification signal. The user apparatus UE may receive the RSU identification signal by monitoring only the especially allocated resource pool. With the above arrangement, it is possible to reduce processing load of the user apparatus UE.

Further, the RSU 1 may transmit, as the RSU identification signal, a synchronization signal generated by using a special synchronization signal sequence (e.g., a synchronization signal exclusive to [identifiable from] other RSUs, user apparatuses UE and base stations eNBs). Upon receiving the synchronization signal including the special synchronization signal sequence, the user apparatus UE can determine that the synchronization signal (RSU identification signal) has been transmitted from the RSU 1.

Further, the RSU 1 may transmit special broadcast information as the RSU identification signal. For example, by including information for identifying the RSU 1 in broadcast information (MIB/SIB) and transmitting the included result, upon receiving the broadcast information, the user apparatus UE can determine that the broadcast information has been transmitted from the RSU 1. It should be noted that, in the case where the RSU 1 is a base station type RSU, the RSU 1 may not only use, not a special synchronization signal sequence, but a synchronization signal of a base station eNB (PSS (Primary Synchronization Signal)/SSS (Secondary Synchronization Signal)), but also include information identifying the RSU 1 in the broadcast information.

Further, the RSU 1 may transmit a D2D signal including a special DM-RS sequence (DM-RS sequence different from other user apparatuses UE and other RSUs). Upon receiving the D2D signal including the special DM-RS sequence, the user apparatus UE can determine that the D2D signal has been transmitted from the RSU 1.

Further, the RSU 1 may transmit a D2D signal (PSCCH, PSSCH, PSDCH, etc.) by using a special carrier (e.g., V2X dedicated carrier for the RSU), or, a special time/frequency resource pool (e.g., RSU dedicated resources). The RSU 1 transmits a D2D signal by using the special carrier or the RSU dedicated resource, and it is possible for the user apparatus UE to determine that the D2D signal has been transmitted from the RSU 1 by obtaining the special carrier or the RSU dedicated resource in advance.

Next, upon detecting the RSU 1, the user apparatus UE transmits a resource allocation request signal to the RSU 1 in order to request the RSU 1 to allocate a radio resource used for D2D communications (S13).

The resource allocation request signal may include a payload size of the D2D signal that the user apparatus UE is going to transmit, a message type (indicating whether a message is to be transmitted by using a PSDCH or by using a PSSCH), and/or information indicating transmission frequency (how frequently the transmission should be performed). By including information indicating the transmission frequency, for example, in the case where the user apparatus UE performs periodical D2D signal transmission, it is not necessary for the user apparatus UE to transmit a resource allocation request signal every time when transmitting a D2D signal, and thus, it is possible to reduce signal amount.

Next, upon receiving the resource allocation request signal, the RSU 1 selects a radio resource allocated for the user apparatus UE from the resource pool (S14). More specifically, in order to cause the radio resources allocated for multiple user apparatuses to be orthogonal to each other, the RSU 1 selects from the resource pool a radio resource other than the radio resources that have already been allocated for other user apparatuses UE. It should be noted that, in the case where the resource allocation request signal includes a payload size, a message type, and/or information indicating the transmission frequency, the RSU 1 selects a radio resource that satisfies the request from the user apparatus UE, and in the case where a radio resource satisfying the request is not available and the request from the user apparatus UE cannot be satisfied, the RSU 1 may select a radio resource that overlaps with resources of a smaller number of user apparatuses UE. The RSU 1 associates with each user apparatus UE the radio resources respectively allocated in the resource pool, and stores the associated resources for each user apparatus UE in a management table or the like.

Next, the RSU 1 transmits a resource allocation indication (reporting) signal to the user apparatus UE (S15). The resource allocation indication signal includes information indicating the radio resource allocated in the processing steps of S14.

The allocated radio resource may be specified by a specific resource position (a DFN [Direct Frame Number], a subframe number, or a subcarrier number). Further, in order to reduce an amount of resource allocation indication signals, the resource pool may be divided into multiple subsets in advance, and the allocated radio resource may be specified by using an identifier that uniquely identifies a subset. Further, the allocated radio resource may be specified by using a frequency resource alone.

Further, the resource allocation indication signal may include a period as in cycle of the allocated radio resource, and/or, an effective time duration of the period (the number of repetitions). By including the period of the allocated radio resource, in the case where the user apparatus UE performs periodical D2D signal transmission, it is not necessary for the user apparatus UE to transmit a resource allocation request signal every time when transmitting a D2D signal, and thus, it is possible to reduce a signal amount. Further, by including the effective time duration of the period, it is possible to prevent the radio resources from being occupied for a long duration of time by the user apparatus UE.

Further, the resource allocation indication signal may include a radio parameter used for transmission power control, etc. With the above arrangement, even in the case where the RSU 1 is a user apparatus type RSU, it is possible to provide transmission power control corresponding to a base station eNB, and thus, it is possible to improve frequency utilization efficiency.

Next, the user apparatus UE transmits a D2D signal according to the allocated radio resource (S16). It should be noted that, in the case where the user apparatus UE is indicated by an upper layer or the like to perform LBT (Listen Before Talk) when transmitting a D2D signal, the user apparatus UE may perform carrier sensing when transmitting the D2D signal through the allocated radio resource. The LBT is a mechanism for preventing a collision of signals transmitted from multiple transmission stations, in which transmission is performed after checking (carrier sensing) whether a communication channel is available before transmitting a signal through the communication channel.

It should be noted that the RSU 1 may include, in the resource allocation indication signal, information indicating whether LBT (Listen Before Talk) is needed, in transmission to the user apparatus UE, and the user apparatus UE may determine whether to perform carrier sensing according to the information indicating whether LBT is needed. It is possible to improve frequency utilization efficiency in D2D communications by making it possible to control necessity of LBT appropriately.

Further, the RSU 1 may determine that a radio resource to be allocated is not used by other user apparatuses UE, etc., by performing carrier sensing in advance when allocating the radio resource in processing steps of S14. Further, in the case where it is determined that the radio resource to be allocated is not used by other user apparatuses UE, etc., the RSU 1 may transmit to the user apparatus UE the allocated radio resource together with information indicating that the LBT is not necessary in processing steps of S15. With the above arrangement, it is possible to prevent duplicated carrier sensing from being performed by the RSU 1 and the user apparatus UE.

Further, the user apparatus UE may determine whether LBT is needed according to the UE type (UE category, etc.) of the user apparatus UE, or may determine whether LBT is needed for each of the transmission message types (a message to be transmitted by a PSDCH, a message to be transmitted by a PSSCH, etc.) Further, in the case where the user apparatus UE transmits a D2D signal according to the radio resource allocated by the RSU 1 in processing steps of S16, the user apparatus UE may transmit a D2D signal without performing carrier sensing even if the user apparatus UE has been indicated in advance by an upper layer, etc., to perform LBT when transmitting a D2D signal.

(Radio Resource Allocation (No. 2))

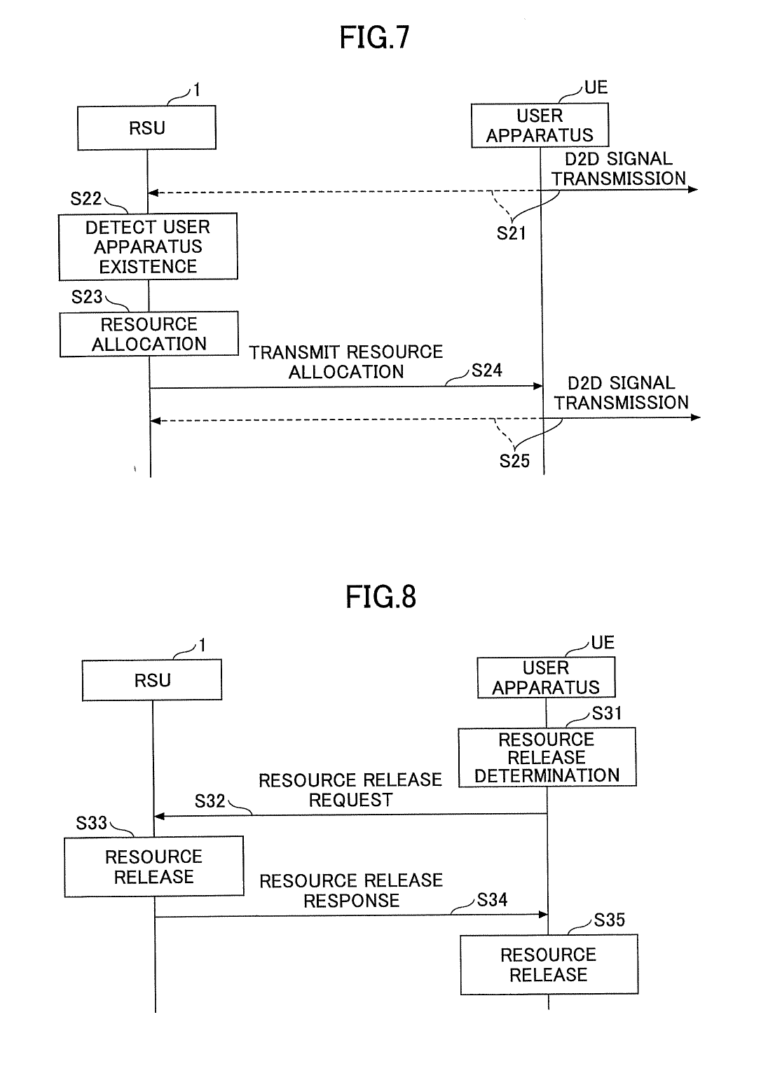

FIG. 7 is a sequence diagram illustrating radio resource allocation processing (No. 2). In the processing steps (No. 2), different from the radio resource allocation processing steps (No. 1), the RSU 1 allocates a radio resource on identifying a presence of the user apparatus UE.

First, the user apparatus UE transmits a D2D signal (S21). The D2D signal may be a D2D signal that the user apparatus UE transmits to another user apparatus UE, or a D2D signal transmitted periodically in order to enable the RSU 1 to detect the user apparatus UE. Next, the RSU 1 receives a D2D signal transmitted in step S21, and the RSU 1 detects that the user apparatus UE exists near the RSU 1 (S22).

Here, the RSU 1 may detect a D2D signal transmitted by the user apparatus UE by monitoring the entire resource pool allocated for a PSCCH, a PSSCH, and a PSDCH, or may detect a D2D signal transmitted by the user apparatus UE by monitoring only a PSCCH. It should be noted that the RSU 1 obtains a UE identifier (an identifier used for uniquely identifying a user apparatus UE), which will be described later, by monitoring a PSCCH, a PSSCH, or a PSDCH.

It should be noted that the user apparatus UE may transmit a D2D signal (a PSCCH, a PSSCH, a PSDCH, etc.) by using a user-apparatus-UE-detection radio resource allocated for the RSU 1 to detect the user apparatus UE, and the RSU 1 may monitor only the user-apparatus-UE-detection radio resource. With the above arrangement, it is possible to reduce processing load of the RSU 1.

The processing steps of S23 to S25 are the same as the processing steps of S14 to S16 in FIG. 6, respectively, and thus, the description will be omitted.

(Radio Resource Release (No. 1))

FIG. 8 is a sequence diagram illustrating radio resource release processing (No. 1). In the processing steps, the user apparatus UE itself requests the RSU 1 to release the radio resource.

First, the user apparatus UE determines whether the user apparatus UE should release a radio resource allocated for the user apparatus UE (S31).

For example, the user apparatus UE may determine that the user apparatus UE should release a radio resource allocated for the user apparatus UE in the case where reception quality (reception power, etc.) of the RSU identification signal (step S11 in FIG. 6) is equal to or less than a predetermined threshold value, or the user apparatus UE may determine that the user apparatus UE should release a radio resource allocated for the user apparatus UE in the case where the RSU identification signal can no longer be detected (received).

Further, the user apparatus UE may determine that the user apparatus UE should release a radio resource allocated for the user apparatus UE in the case where another RSU 1 is detected whose RSU identification signal reception quality is better than that of the RSU 1 from which the radio resource allocation has been received.

Further, the user apparatus UE may obtain its position according to GPS (Global Positioning System) or the like, and may determine that the user apparatus UE should release a radio resource allocated for the user apparatus UE in the case where it is determined that a physical distance between the user apparatus UE and the RSU 1 is equal to or greater than a predetermined distance.

Further, the user apparatus UE may determine that the user apparatus UE should release a radio resource allocated for the user apparatus UE in the case where a predetermined time has elapsed since the radio resource allocation was received. Further, in the case where an effective time duration has been set in the allocated radio resource, the user apparatus UE may determine that the user apparatus UE should release a radio resource allocated for the user apparatus UE in the case where the effective time duration has elapsed.

Next, the user apparatus UE transmits a resource release request signal to the RSU 1 (S32). Upon receiving the resource release request signal, the RSU 1 releases the radio resource that has been allocated for the user apparatus UE in the resource pool (S33). Specifically, the RSU 1 removes the released radio resource from the above-described management table or the like.

Next, in order to report to the user apparatus UE that the release of the radio resource has been completed, the RSU 1 transmits a resource release response signal to the user apparatus UE (S34). The user apparatus UE releases the radio resource allocated for the user apparatus UE (S35). Specifically, the user apparatus UE removes information related to the radio resource allocated by the RSU 1 from a memory, etc.

It should be noted that the RSU 1 allocates the released radio resource to another user apparatus UE whose existence has been newly detected. With the above arrangement, it is possible to efficiently utilize limited radio resources.

(Radio Resource Release (No. 2))

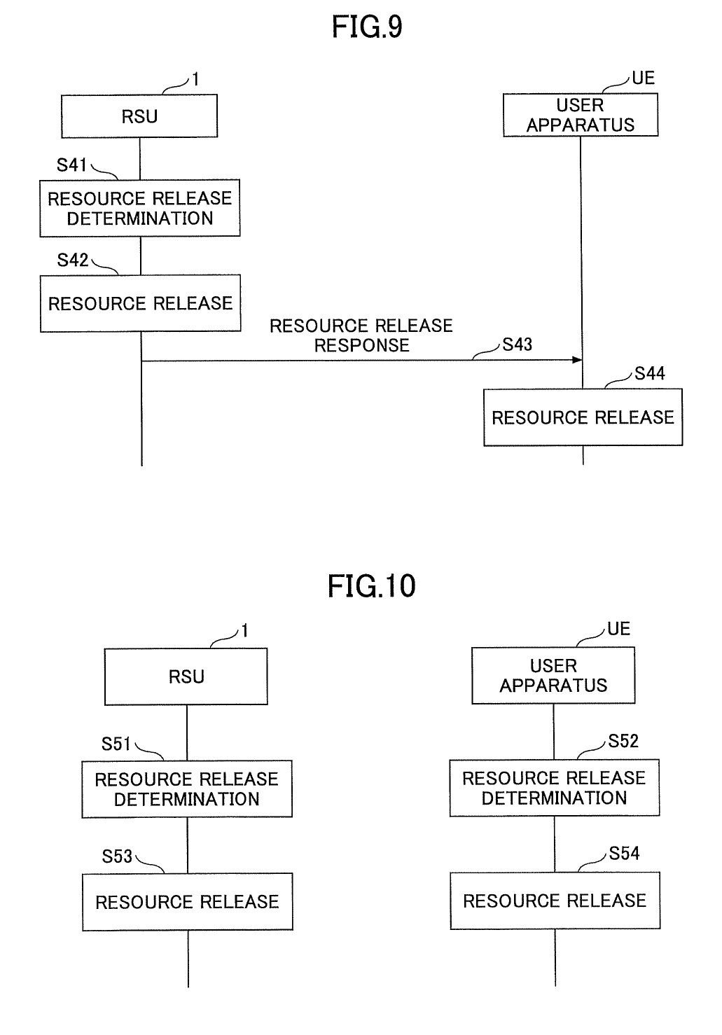

FIG. 9 is a sequence diagram illustrating radio resource release processing (No. 2). In the processing steps, different from the processing steps of the radio resource release processing (No. 1), it is the RSU 1 that determines whether the radio resource should be released.

First, the RSU 1 determines whether the radio resource that has been allocated to the user apparatus UE should be released (S31).

For example, the RSU 1 may determine that the radio resource that has been allocated to the user apparatus UE should be released in the case where reception quality (reception power, etc.) of the D2D signal transmitted by the user apparatus UE (step S21 in FIG. 7) is equal to or less than a predetermined threshold value, or the RSU 1 may determine that the radio resource that has been allocated to the user apparatus UE should be released in the case where the D2D signal can no longer be detected.

Further, the RSU 1 may cause the user apparatus UE to report its position periodically, and may determine that the radio resource that has been allocated to the user apparatus UE should be released in the case where it is determined that a physical distance between the user apparatus UE and the RSU 1 is equal to or greater than a predetermined distance.

Further, the RSU 1 may determine that the radio resource that has been allocated to the user apparatus UE should be released in the case where a predetermined time has elapsed since the radio resource was allocated to the user apparatus UE by the RSU 1. Further, in the case where the RSU 1 has set an effective time duration in the allocated radio resource, the RSU 1 may determine that the radio resource that has been allocated to the user apparatus UE should be released in the case where the effective time duration has elapsed.

The processing steps of S42 to S44 are the same as the processing steps of S33 to S35 in FIG. 8, respectively, and thus, the description will be omitted.

(Radio Resource Release (No. 3))

FIG. 10 is a sequence diagram illustrating radio resource release processing (No. 3). In the processing steps, the user apparatus UE and the RSU 1 release the radio resource on each determining whether the radio resource should be released.

Step S51 and step S53 are the same as step S41 and step S42 of FIG. 9, respectively, and thus, the description will be omitted. Step S52 and step S54 are the same as step S31 and step S35 of FIG. 8, respectively, and thus, the description will be omitted.

It should be noted that, in step S53, in order to prevent an occurrence of not releasing a radio resource, in the case where a predetermined time has elapsed since the RSU 1 allocated a radio resource to the user apparatus UE, the RSU 1 may forcibly release the radio resource that has been allocated to the user apparatus UE.

(Supplementary Descriptions Related to Various Signals)

The above-described resource allocation request signal, the resource allocation indication signal, the resource release request signal, and the resource release response signal may be control information in the layer 1 or layer 2, or may be included in a sub-header in the MAC header.

Further, in the case where the resource allocation request signal includes various information items (e.g., payload size, message type, and information indicating transmission frequency), the various information items may be explicitly indicated, or may be implicitly indicated by using an association with the resource allocation request signal. Similarly, in the case where the resource allocation indication signal includes various information items (e.g., a period of the allocated radio resource, an effective period of the period, radio parameters related to transmission power control, etc., information indicating whether LBT is needed, etc.), the various information items may be explicitly indicated, or may be implicitly indicated by using an association with the resource allocation indication signal.

Further, the resource allocation request signal, the resource allocation indication signal, the resource release request signal, and the resource release response signal may be transmitted and received not only by using physical channels defined in D2D (PSDCH, PSCCH, PSSCH) but also, for example, a physical channel or a logical channel newly defined for communications with the RSU. Further, in order to avoid interference from D2D communications performed by other user apparatuses UE, etc., and to avoid a signal loss and a reception failure due to an effect of limitations (e.g., the user apparatus UE cannot perform transmission and reception simultaneously) of half duplex communications that are characteristic of D2D communications, the above-described signals may be transmitted and received by using, for example, a specific resource pool that has been predefined for communications with RSU (that is, a resource pool that is multiplexed with other resource pools in the time direction or the frequency direction).

Further, the resource allocation request signal, the resource allocation indication signal, the resource lease request signal, and the resource release response signal may be transmitted and received via other carriers with different frequencies. With the above arrangement, it is possible to avoid interference with D2D communications.

(Supplementary Descriptions Related to Specifying a User Apparatus UE)

The user apparatus UE includes an identifier that is used for uniquely identifying the user apparatus UE in the resource allocation request signal and in the resource release request signal (hereinafter, referred to as “UE identifier”), in transmission to the RSU 1. With the above arrangement, it is possible for the RSU 1 that has received the signals to uniquely identify the user apparatus UE. The UE identifier may be a ProSe UE ID included in transmission source information of the MAC header (SRC: The Source Layer-2 ID) or a SLID (Sidelink ID) used in the layer 1.

Further, the resource allocation indication signal and the resource release response signal transmitted from the RSU 1 are signals that are transmitted to a specific user apparatus UE. Therefore, the UE identifier (ProSe UE ID, SLID, or resource index) may be included in the payload of the resource allocation indication signal and the resource release response signal, or a CRC (Cyclic Redundancy Check) of the resource allocation indication signal and the resource release response signal may be masked with all or a part of the UE identification.

Further, in the case where the RSU 1 is a base station type RSU, the resource allocation indication signal and the resource release response signal may be transmitted as a part of DCI (Downlink Control Information) by using an (E)PDCCH that is masked with the UE identifier (e.g., a special RNTI (Radio Network Temporary ID)). In this case, the DCI's resource or search space may be transmitted to the user apparatus UE in advance by using broadcast information (SIB), etc. Further, the DCI may include all or a part of the UE identifier. With all or a part of the UE identifier included in the DCI, it is possible for each user apparatus UE to recognize a radio resource that has been allocated for a user apparatus UE other than the user apparatus UE, and thus, it is possible to avoid D2D signal collision proactively.

Further, in the case where the RSU 1 is a base station type RSU, the user apparatus UE may transmit the UE identifier to the RSU 1 by performing a random access procedure through a specially defined PRACH (Physical Random Access Channel) and a preamble sequence. For example, the RSU 1 may use as the UE identifier a preamble transmitted from the user apparatus UE by using a Message1 defined in the random access procedure. Further, the user apparatus UE may transmit the UE identifier by using a Message3 defined in the random access procedure. Further, the random access procedure is used for transmitting the UE identifier to the RSU 1, and thus, the random access procedure may be a special random access procedure in which an RRC connection between the RSU 1 and the user apparatus UE is not established. In other words, a Message2 or a Message4 according to the conventional random access procedure may not be transmitted to the user apparatus UE.

### Functional Structure

In the following, functional structure examples of the user apparatus UE and the RSU 1 which perform operations according to an embodiment will be described.

(User Apparatus)

FIG. 11 is a drawing illustrating an example of a functional structure of a user apparatus UE according to an embodiment. As illustrated in FIG. 11, the user apparatus UE includes a signal transmission unit 101, a signal reception unit 102, a detection unit 103, and a request unit 104. It should be noted that FIG. 11 illustrates functional units of the user apparatus UE only as especially related to an embodiment, and thus, the user apparatus UE further includes at the least functions for performing operations according to LTE (not shown in the figure). Further, a functional structure illustrated in FIG. 11 is merely an example. Any functional classification and any names of functional units may be applied as long as operations related to an embodiment can be performed.

The signal transmission unit 101 includes a function for wirelessly transmitting various types of physical layer signals generated from an upper layer signal which should be transmitted from the user apparatus UE. Further, the signal transmission unit 101 have a transmission function of D2D signals (SCI, MAC PDU, etc.) and a transmission function of cellular communications.

Further, the signal transmission unit 101 transmits a D2D signal according to the radio resource allocated by the RSU 1. Further, in the case where the user apparatus UE is indicated by an upper layer, etc., to perform LBT when transmitting a D2D signal, the user apparatus UE may perform carrier sensing when transmitting a D2D signal through the allocated radio resource.

Further, when transmitting a D2D signal, the signal transmission unit 101 may determine whether or not to perform carrier sensing for the allocated radio resource when transmitting a D2D signal according to a type of the user apparatus UE or a type of a message transmitted by the D2D signal.

The signal reception unit 102 includes a function for wirelessly receiving various kinds of signals from another user apparatus UE or the base station eNB, and obtaining upper layer signals from the received physical layer signals. Further, the signal reception unit 102 has a function for receiving D2D signals (SCI, MAC PDU, etc.) and a function for receiving cellular communications.

The detection unit 103 has a function for detecting (obtaining) an existence of the RSU 1 by receiving an RSU identification signal transmitted by the RSU 1.

The request unit 104 has a function for transmitting a resource allocation request signal to the RSU 1 via the signal transmission unit 101 in order to request the RSU 1 to allocate a radio resource used for D2D communications.

Further, the request unit 104 may include, in the resource allocation request signal, information indicating a transmission period of a D2D signal the user apparatus UE is going to transmit, in transmission to the RSU 1.

Further, in the case where reception quality (reception power, etc.) of the RSU identification signal transmitted from the RSU 1 is equal to or less than a predetermined threshold value, in the case where the identification signal transmitted from the RSU 1 cannot be received, in the case where reception quality of an RSU identification signal transmitted from an RSU 1 different from the RSU 1 from which the radio resource allocation has been received is greater than the reception quality (reception power, etc.) of the RSU identification signal transmitted from the RSU 1 from which the radio resource allocation has been received, in the case where it is determined that a distance between the user apparatus UE and the control apparatus is equal to or greater than a predetermined distance, or, in the case where a predetermined time has elapsed after receiving the radio resource allocation, the request unit 104 may transmit a resource release request signal to the RSU in order to request the RSU to release the radio resource.

(RSU)

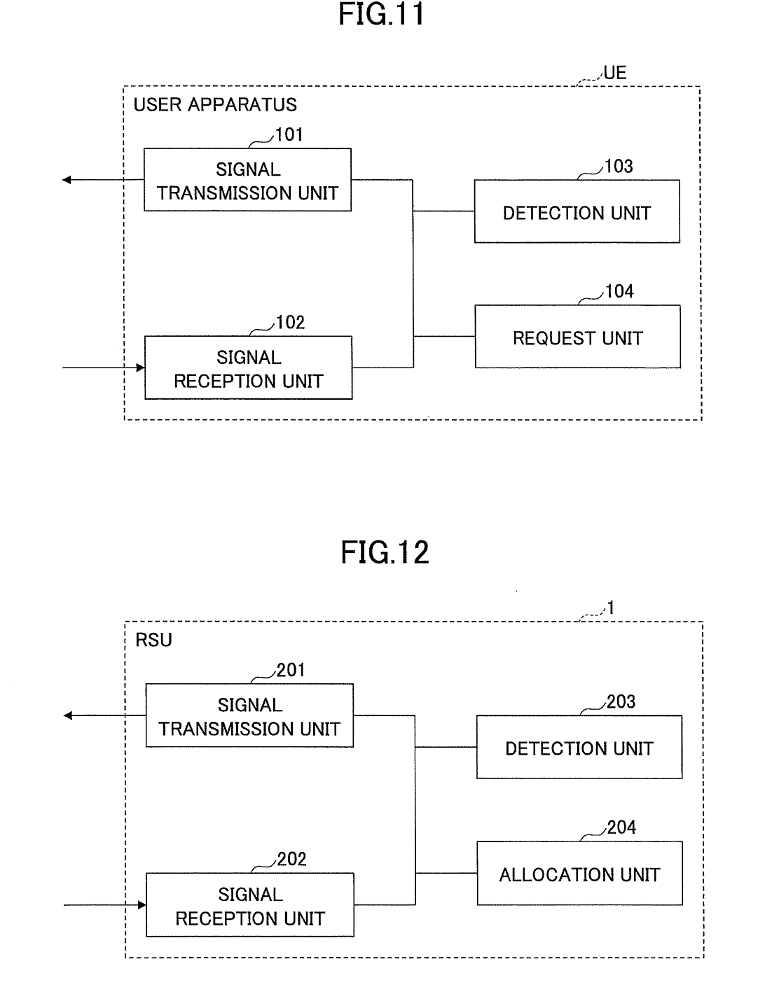

FIG. 12 is a drawing illustrating an example of a functional structure of an RSU 1 according to an embodiment. As illustrated in FIG. 12, the RSU 1 includes a signal transmission unit 201, a signal reception unit 202, a detection unit 203, and an allocation unit 204. It should be noted that FIG. 12 only illustrates functional units of the RSU 1 especially related to an embodiment, and thus the RSU 1 further includes at the least functions for performing operations according to LTE (not shown in the figure). Further, a functional structure illustrated in FIG. 12 is merely an example. Any functional classification and any names of functional units may be applied as long as operations related to an embodiment can be performed.

The signal transmission unit 201 includes a function for wirelessly transmitting various types of physical layer signals generated from an upper layer signal which should be transmitted from the RSU 1. Further, the signal transmission unit 201 has a transmission function of D2D signals (SCI, MAC PDU, etc.) and/or a transmission function of cellular communications. Further, the signal transmission unit 201 transmits a resource allocation indication signal to the user apparatus UE in order to indicate (transmit/report) the radio resource for D2D communications allocated by the allocation unit 204 to the user apparatus UE.

Further, the signal transmission unit 201 may include, in the resource allocation indication signal, information indicating whether it is necessary to perform carrier sensing for the allocated radio resource for the D2D communications, in transmission to the user apparatus UE. Further, the signal transmission unit 201 may include, in the resource allocation indication signal, information indicating that it is not necessary to perform carrier sensing for the allocated radio resource for the D2D communications according to an instruction from the allocation unit 204, in transmission to the user apparatus UE.

The signal reception unit 202 includes a function for wirelessly receiving various kinds of signals from the user apparatus UE, and obtaining upper layer signals from the received physical layer signals. Further, the signal transmission unit 202 has a reception function of D2D signals (SCI, MAC PDU, etc.) and/or a reception function of cellular communications.

The detection unit 203 has a function for detecting (obtaining) a presence of the user apparatus UE by receiving a D2D signal transmitted from the user apparatus UE.

Further, the detection unit 203 may detect the user apparatus UE by monitoring a radio resource, of the radio resources used for D2D communications, allocated for detecting the user apparatus UE (a radio resource for detecting user apparatus UE).

The allocation unit 204 has a function for allocating radio resources used for D2D signal transmission by the user apparatus UE in the case where a presence of a user apparatus UE has been detected by the detection unit 203. Further, the allocation unit 204 may allocate the radio resource after checking D2D signal transmission availability by performing carrier sensing in advance for the radio resource to be allocated.

Further, in the case where a resource release request signal is received from the user apparatus UE, in the case where reception quality (reception power, etc.) of a D2D signal transmitted from the user apparatus UE is equal to or less than a predetermined threshold value, in the case where a D2D signal transmitted from the user apparatus UE cannot be received, in the case where it is determined that a distance between the user apparatus UE and the RSU 1 is equal to or greater than a predetermined distance, or, in the case where a predetermined time has elapsed since the radio resource was allocated for the user apparatus UE, the allocation unit 204 may release the radio resource allocated for the user apparatus UE.

### Hardware Configuration

Block diagrams (FIG. 11 and FIG. 12) used for describing an embodiment indicate functional unit blocks. These functional blocks (functional units) are realized by any suitable combination of hardware and/or software. Further, realizing means of the functional blocks is not specifically limited. In other words, each functional block may be realized by a physically and/or logically coupled single apparatus, or may be realized by multiple apparatuses which are physically and/or logically separated and directly and/or indirectly connected (for example, with a wire and/or wirelessly).

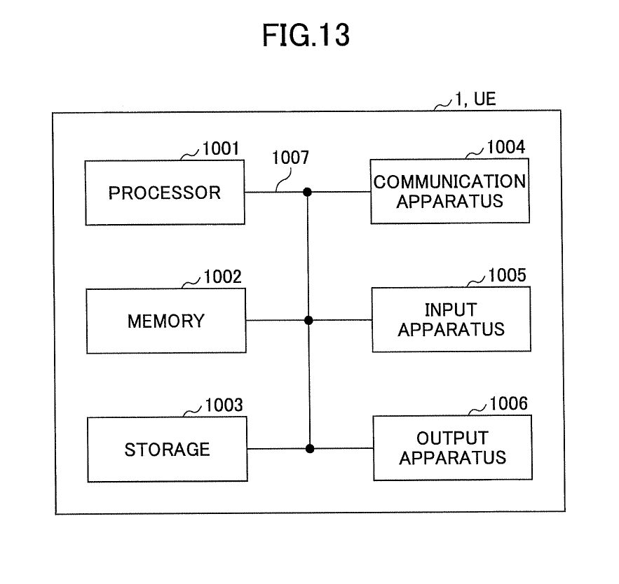

For example, the user apparatus UE and the RSU 1 according to an embodiment may be realized as computers performing processes of a radio communication method of the present invention. FIG. 13 is a drawing illustrating an example of a hardware configuration of the user apparatus UE and the RSU 1 according to an embodiment. The above-described user apparatus UE and the RSU 1 may be physically realized by computer apparatuses including a processor 1001, a memory 1002, a storage 1003, a communication apparatus 1004, an input apparatus 1005, an output apparatus 1006, and a bus 1007.

It should be noted that the term “apparatus” in the following description may be read as a circuit, a device, a unit, etc. The hardware configuration of the user apparatus UE and the RSU 1 may be realized by including one or more apparatuses illustrated in the drawing, or may be realized by not including some of the apparatuses.

Functions of the user apparatus UE and the RSU 1 are realized by causing predetermined software (program) to be read into hardware such as the processor 1001 and the memory 1002, by causing the processor 1001 to perform calculations, and by causing the processor 1001 to control communications performed by the communication apparatus 1004, and data reading and writing to and from the memory 1002 and the storage 1003.

The processor 1001 controls the entire computer by using the operating system. The processor 1001 may be a Central Processing Unit (CPU) including an interface with a peripheral apparatus, a control apparatus, a calculation apparatus, and a register. For example, the signal transmission unit 101, the signal reception unit 102, a detection unit 103, and the request unit 104 of the user apparatus UE; the signal transmission unit 201, the signal reception unit 202, the detection unit 203, and the allocation unit 204 of the RSU 1 may be realized by the processor 1001.

Further, the processor 1001 reads programs (program codes), software modules, or data from the storage 1003 and/or the communication apparatus 1004 into the memory 1002, and performs various processes according to the read programs, software modules, or data. The programs are used for causing the computer to perform at least a part of the operations described in an embodiment. For example, the signal transmission unit 101, the signal reception unit 102, the detection unit 103, and the request unit 104 of the user apparatus UE; the signal transmission unit 201, the signal reception unit 202, the detection unit 203, and the allocation unit 204 of the RSU 1 may be realized by control programs stored in the memory 1002 and executed by the processor 1001, and other functional blocks may be realized in the same way. The above processes are described as performed by a single processor 1001. However, the processes may be performed simultaneously or sequentially by two or more processors 1001. The processor 1001 may be implemented by one or more chips. It should be noted that the programs may be transmitted from a network via telecommunication lines.

The memory 1002 is a computer-readable recording medium, and may include, for example, at least one of a Read Only Memory (ROM), an Erasable Programmable ROM (EPROM), an Electrically Erasable Programmable ROM (EEPROM), and a Random Access Memory (RAM). The memory 1002 may be referred to as a register, a cache, a main memory, etc. The memory 1002 can store programs (program codes), software modules, etc., executable for performing radio communication methods according to an embodiment.

The storage 1003 is a computer-readable recording medium, and may include at least one of an optical disk including a Compact Disc ROM (CD-ROM), a hard disk drive, a flexible disk, a magneto optical disk (e.g., a compact disk, a digital versatile disk, a Blu-ray [registered trademark] disk), a smart card, a flash memory (e.g., a card, a stick, a key drive), a floppy (registered trademark) disk, a magnetic strip, etc. The storage 1003 may be referred to as an auxiliary storage apparatus. The above-described recording medium may be a database, a server, or any other appropriate medium including the memory 1002 and/or the storage 1003.

The communication apparatus 1004 is hardware for performing communications between computers via a wired network and/or a wireless network (transmitting and receiving device), and may be referred to as, for example, a network device, a network controller, a network card, a communication module, etc. For example, the signal transmission unit 101 and the signal reception unit 102 of the user apparatus UE and the signal transmission unit 201 and the signal reception unit 202 of the RSU 1 may be realized by the communication apparatus 1004.

The input apparatus 1005 is an input device (e.g., a keyboard, a mouse, a microphone, a switch, a button, and a sensor) used for accepting an input from outside. The output apparatus 1006 is an output device (e.g., a display, a speaker, an LED lamp) used for performing an output to outside. It should be noted that the input apparatus 1005 and the output apparatus 1006 may be integrated as a single apparatus (e.g., a touch panel).

Further, apparatuses including the processor 1001 and the memory 1002 are connected to each other by the bus 1007 used for communicating information. The bus 1007 may be a single bus, or may be buses differing between the apparatuses.

Further, the user apparatus UE and the RSU 1 may include hardware such as a microprocessor, a Digital Signal Processor (DSP), an Application Specific Integrated Circuit (ASIC), a Programmable Logic Device (PLD), and a Field Programmable Gate Array (FPGA). A part or all of the functional blocks may be realized by the above hardware. For example, the processor 1001 may be implemented by at least one of the above hardware.

### Summary

A control apparatus according to an embodiment is provided. The control apparatus is provided for a wireless communication system that includes the control apparatus, which performs radio resource allocation for D2D communications, and a user apparatus. The control apparatus includes a detection unit configured to detect the user apparatus by receiving a D2D signal transmitted from the user apparatus; an allocation unit configured to allocate a specific radio resource to be used by the user apparatus for transmitting the D2D signal, in the case where the user apparatus is detected; and a transmission unit configured to transmit a signal indicating the allocated specific radio resource to the user apparatus. According to the above-described control apparatus, a technology is provided in which it is possible to efficiently allocate radio resources used for D2D communications.

The detection unit may detect the user apparatus by monitoring a radio resource, of the radio resources used for D2D communications, allocated for detecting the user apparatus. With the above arrangement, it is not necessary for the RSU 1 to monitor the entire resource pools in order to detect the user apparatus UE, and thus, it is possible to reduce processing load of the RSU 1.

Further, in the case where a signal requesting the RSU 1 to release the specific radio resource is received from the user apparatus, in the case where reception quality (reception power, etc.)

of a D2D signal transmitted from the user apparatus is equal to or less than a predetermined threshold value, in the case where a D2D signal transmitted from the user apparatus cannot be received, in the case where it is determined that a distance between the user apparatus and the control apparatus is equal to or greater than a predetermined distance, or, in the case where a predetermined time has elapsed since the radio resource was allocated, the allocation unit may release the specific radio resource. With the above arrangement, it is possible to release the radio resource allocated for the user apparatus UE and it is possible to allocate the released radio resource to another user apparatus UE, and thus, it is possible to efficiently utilize radio resources.

Further, the allocation unit may allocate the specific radio resource by checking availability of the D2D signal transmission by using carrier sensing, and the transmission unit may include, in the signal indicating the specific radio resource, information indicating that it is not necessary to perform carrier sensing in the specific radio resource, in transmission to the user apparatus. With the above arrangement, it is possible to perform carrier sensing processing at the RSU side and it is possible to perform D2D communications without performing the carrier sensing at the user apparatus UE side, and thus, it is possible to reduce processing load of the user apparatus UE and it is possible to increase frequency utilization efficiency.

Further, a user apparatus according to an embodiment is provided. The user apparatus is provided for a wireless communication system that includes a control apparatus, which performs radio resource allocation for D2D communications, and the user apparatus. The user apparatus includes a detection unit configured to detect the control apparatus by receiving an identification signal transmitted from the control apparatus; a request unit configured to transmit a signal to the detected control apparatus requesting the detected control apparatus to allocate a radio resource for D2D communications; and a transmission unit configured to transmit a D2D signal by using the specific radio resource for D2D communications allocated by the control apparatus. According to the above-described user apparatus UE, a technology is provided in which it is possible to efficiently allocate radio resources used for D2D communications.

Further, the request unit may include, in the signal requesting the radio resource allocation, information indicating a transmission period of the D2D signal, in transmission to the control apparatus. With the above arrangement, in the case where the user apparatus UE performs periodical D2D signal transmission, it is not necessary for the user apparatus UE to transmit a resource allocation request signal every time when transmitting a D2D signal, and thus, it is possible to reduce signal amount.

Further, in the case where reception quality of an identification signal transmitted from the control apparatus is equal to or less than a predetermined threshold value, in the case where the identification signal transmitted from the control apparatus cannot be received, in the case where reception quality of an identification signal transmitted from a control apparatus different from the control apparatus is greater than the reception quality of the identification signal transmitted from the control apparatus, in the case where it is determined that a distance between the user apparatus and the control apparatus is equal to or greater than a predetermined distance, or, in the case where a predetermined time has elapsed since the specific radio resource was allocated, the request unit may transmit a release request signal to the control apparatus in order to request the control apparatus to release the specific radio resource. With the above arrangement, it is possible for the RSU 1 to allocate the released radio resource to other user apparatuses UE, and thus, it is possible to utilize the radio resources efficiently.

Further, the signal transmission unit may determine whether or not to perform carrier sensing for the allocated radio resource when transmitting a D2D signal according to a type of the user apparatus or a type of a message transmitted by the D2D signal. With the above arrangement, it is possible to switch between performing the carrier sensing and not performing the carrier sensing as necessary, and it is possible to increase frequency utilization efficiency.

Further, a radio resource allocation method performed by a control apparatus according to an embodiment is provided. The control apparatus is provided for a wireless communication system that includes the control apparatus, which performs radio resource allocation for D2D communications, and a user apparatus. The radio resource allocation method includes detecting the user apparatus by receiving a D2D signal transmitted from the user apparatus; allocating a specific radio resource to be used by the user apparatus for transmitting a D2D signal in the case where the user apparatus is detected; and transmitting a signal indicating the allocated specific radio resource to the user apparatus. According to the above-described radio resource allocation method, a technology is provided in which it is possible to efficiently allocate radio resources used for D2D communications.

Further, a communication method performed by a user apparatus according to an embodiment is provided. The user apparatus is provided for a wireless communication system that includes a control apparatus, which performs radio resource allocation for D2D communications, and the user apparatus. The communication method includes detecting the control apparatus by receiving an identification signal transmitted from the control apparatus; transmitting a signal requesting radio resource allocation for D2D communications to the detected control apparatus; and transmitting a D2D signal by using the specific radio resource for D2D communications allocated by the control apparatus. According to the above-described communication method, a technology is provided in which it is possible to efficiently allocate radio resources used for D2D communications.

### Supplementary Description of Embodiment

The above-described processing steps of the radio resource allocation processing (No. 1), the processing steps of the radio resource allocation processing (No. 2), the processing steps of the radio resource release processing (No. 1), the processing steps of the radio resource release processing (No. 2), and the processing steps of the radio resource release processing (No. 3) may be combined arbitrarily, or may be combined differently for each of the user apparatuses UE.

The PSCCH according to an embodiment may be another control channel as long as it is a control channel for transmitting control information used for D2D communications (SCI, etc.) Further, the PSSCH may be another data channel as long as it is a data channel for transmitting data (MAC PDU, etc.) used for D2D communications. Further, the PSDCH may be another data channel as long as it is a data channel for transmitting data used for D2D Discovery of D2D communications (discovery message, etc.)

The D2D signal, the RRC signal, and the control signal may be a D2D message, an RRC message, and a control message, respectively.

A claimed method recites various step elements in a sample order, and, unless otherwise explicitly stated in claims, the order is not limited to the recited specific order.

An embodiment of the present invention may be enhanced to be used in a system that uses LTE, LTE-A, CDMA2000, UMB (Ultra Mobile Broadband), IEEE802.11 (Wi-Fi [registered trademark]), IEEE802.16 (WiMAX [registered trademark]), IEEE802.20, UWB (Ultra-Wideband), Bluetooth (registered trademark), and/or other appropriate schemes.

In the above descriptions, the apparatuses (user apparatus UE/RSU 1) according to an embodiment may include a CPU and a memory, may be realized by having a program executed by the CPU (processor), may be realized by hardware such as hardware circuitry in which the logic described in an embodiment is included, or may be realized by a combination of a program and hardware.

As described above, embodiments have been described. The disclosed invention is not limited to these embodiments, and a person skilled in the art would understand various variations, modifications, replacements, or the like. Specific examples of numerical values may be used for encouraging understanding of the present invention. These numerical values are merely examples and, unless otherwise noted, any appropriate values may be used. In the above description, partitioning of items is not essential to the present invention. Contents described in more than two items may be combined if necessary. Contents described in one item may be applied to contents described in another item (as long as they do not conflict). In a functional block diagram, boundaries of functional units or processing units do not necessarily correspond to physical boundaries of parts. Operations of multiple functional units may be physically performed in a single part, or operations of a single functional unit may be physically performed by multiple parts. The order of steps in the above described sequences and flowcharts according to an embodiment may be changed as long as there is no contradiction. For the sake of description convenience, the user apparatuses UE/RSU 1 have been described using functional block diagrams. These apparatuses may be implemented by hardware, by software, or by a combination of both. The software which is executed by a processor included in a user apparatus UE according to an embodiment and the software which is executed by a processor included in a RSU 1 may be stored in a random access memory (RAM), a flash memory, a read-only memory (ROM), an EPROM, an EEPROM, a register, a hard disk drive (HDD), a removable disk, a CD-ROM, a database, a server, or any other appropriate recording medium.

It should be noted that, in an embodiment, the RSU 1 is an example of the control apparatus. The resource allocation indication signal is a signal indicating a specific radio resource. The resource release request signal is a signal requesting the release of the specific radio resource. The RSU identification signal is an example of the identification signal. The resource allocation request signal is an example of a signal requesting radio resource allocation.

The present application is based on and claims the benefit of priority of Japanese Priority Application No. 2015-159993 filed on Aug. 13, 2015, the entire contents of which are hereby incorporated by reference.

### DESCRIPTION OF THE REFERENCE NUMERALS

UE User apparatus

eNB Base station

101 Signal transmission unit

102 Signal reception unit

103 Detection unit

104 Requesting unit

201 Signal transmission unit

202 Signal reception unit

203 Detection unit

204 Allocation unit

1001 Processor

1002 Memory

1003 Storage

1004 Communication apparatus

1005 Input apparatus

1006 Output apparatus

1. A control apparatus in a wireless communication system including the control apparatus, which allocates radio resources for D2D communications, and a user apparatus, the control apparatus comprising:
a detection unit configured to detect the user apparatus by receiving a D2D signal transmitted from the user apparatus;
an allocation unit configured to allocate a specific radio resource used for transmission of a D2D signal by the user apparatus in the case where the user apparatus is detected by the detection unit; and
a transmission unit configured to transmit a signal indicating the allocated specific radio resource to the user apparatus.

2. The control apparatus according to claim 1, wherein the detection unit detects the user apparatus by monitoring a radio resource, of the radio resources used for D2D communications, allocated for detecting the user apparatus.

3. The control apparatus according to claim 1, wherein the allocation unit releases the specific radio resource in the case where a signal requesting the specific radio resource to be released is received from the user apparatus, in the case where reception quality of a D2D signal transmitted from the user apparatus is equal to or less than a predetermined threshold value, in the case where a D2D signal transmitted from the user apparatus cannot be received, in the case where it is determined that a distance between the user apparatus and the control apparatus is equal to or greater than a predetermined distance, or, in the case where a predetermined time has elapsed since the specific radio resource was allocated.

4. The control apparatus according to claim 1, wherein the allocation unit allocates the specific radio resource by checking transmission availability of a D2D signal by using carrier sensing, and
the transmission unit includes, in the signal indicating the specific radio resource, information indicating that it is not necessary to perform carrier sensing for the specific radio resource, and transmits the signal to the user apparatus.

5. A user apparatus in a wireless communication system including a control apparatus that allocates radio resources for D2D communications and the user apparatus, the user apparatus comprising:
a detection unit configured to detect the control apparatus by receiving an identification signal transmitted from the control apparatus;
a request unit configured to transmit a signal requesting allocation of a radio resource for D2D communications; and
a transmission unit configured to transmit a D2D signal by using a specific radio resource for D2D communications allocated by the control apparatus.

6. The user apparatus according to claim 5, wherein the request unit includes, in the signal requesting allocation of a radio resource, information indicating a transmission period of the D2D signal, and transmits the signal to the control apparatus.

7. The user apparatus according to claim 5, wherein the request unit transmits to the control apparatus a release request signal requesting the control apparatus to release the specific radio resource in the case where reception quality of an identification signal transmitted from the control apparatus is equal to or less than a predetermined threshold value, in the case where an identification signal transmitted from the control apparatus cannot be received, in the case where reception quality of an identification signal transmitted from a control apparatus different from the control apparatus is greater than the reception quality of an identification signal transmitted from the control apparatus, in the case where it is determined that a distance between the user apparatus and the control apparatus is equal to or greater than a predetermined distance, or, in the case where a predetermined time has elapsed since the specific radio resource was allocated.

8. The user apparatus according to claim 5, wherein the signal transmission unit determines whether or not to perform carrier sensing for the allocated radio resource when transmitting a D2D signal, according to a type of the user apparatus or a type of a message transmitted by the D2D signal.

9. A radio resource allocation method performed by a control apparatus in a wireless communication system including the control apparatus, which allocates radio resources for D2D communications, and a user apparatus, the radio resource allocation method comprising:
detecting the user apparatus by receiving a D2D signal transmitted from the user apparatus;
allocating a specific radio resource used for transmission of a D2D signal by the user apparatus in the case where the user apparatus is detected; and
transmitting a signal indicating the allocated specific radio resource to the user apparatus.

10. A communication method performed by a user apparatus in a wireless communication system including a control apparatus that allocates radio resources for D2D communications and the user apparatus, the communication method comprising:
detecting the control apparatus by receiving an identification signal transmitted from the control apparatus;
transmitting a signal requesting allocation of a radio resource for D2D communications; and
transmitting a D2D signal by using the specific radio resource for D2D communications allocated by the control apparatus.

11. The control apparatus according to claim 2, wherein the allocation unit releases the specific radio resource in the case where a signal requesting the specific radio resource to be released is received from the user apparatus, in the case where reception quality of a D2D signal transmitted from the user apparatus is equal to or less than a predetermined threshold value, in the case where a D2D signal transmitted from the user apparatus cannot be received, in the case where it is determined that a distance between the user apparatus and the control apparatus is equal to or greater than a predetermined distance, or, in the case where a predetermined time has elapsed since the specific radio resource was allocated.

12. The control apparatus according to claim 2, wherein the allocation unit allocates the specific radio resource by checking transmission availability of a D2D signal by using carrier sensing, and
the transmission unit includes, in the signal indicating the specific radio resource, information indicating that it is not necessary to perform carrier sensing for the specific radio resource, and transmits the signal to the user apparatus.

13. The control apparatus according to claim 3, wherein the allocation unit allocates the specific radio resource by checking transmission availability of a D2D signal by using carrier sensing, and
the transmission unit includes, in the signal indicating the specific radio resource, information indicating that it is not necessary to perform carrier sensing for the specific radio resource, and transmits the signal to the user apparatus.

14. The user apparatus according to claim 6, wherein the request unit transmits to the control apparatus a release request signal requesting the control apparatus to release the specific radio resource in the case where reception quality of an identification signal transmitted from the control apparatus is equal to or less than a predetermined threshold value, in the case where an identification signal transmitted from the control apparatus cannot be received, in the case where reception quality of an identification signal transmitted from a control apparatus different from the control apparatus is greater than the reception quality of an identification signal transmitted from the control apparatus, in the case where it is determined that a distance between the user apparatus and the control apparatus is equal to or greater than a predetermined distance, or, in the case where a predetermined time has elapsed since the specific radio resource was allocated.

15. The user apparatus according to claim 6, wherein the signal transmission unit determines whether or not to perform carrier sensing for the allocated radio resource when transmitting a D2D signal, according to a type of the user apparatus or a type of a message transmitted by the D2D signal.

16. The user apparatus according to claim 7, wherein the signal transmission unit determines whether or not to perform carrier sensing for the allocated radio resource when transmitting a D2D signal, according to a type of the user apparatus or a type of a message transmitted by the D2D signal.
